(19) United States
(12) Patent Application Publication
(10) Pub. No.: US 2026/0359057 A1
(43) Pub. Date: Nov. 12, 2026

(54) DATA PROCESSING METHOD, APPARATUS, ELECTRONIC DEVICE, AND STORAGE MEDIUM

(71) Applicant: Beijing Zitiao Network Technology Co., Ltd., Beijing (CN)

(72) Inventor: Zhixin Wu, Beijing (CN)

(21) Appl. No.: 19/515,776

(22) PCT Filed: Sep. 2, 2024
(86) PCT No.: PCT/CN2024/116352

§ 371 Date: Mar. 2, 2026

(30) Foreign Application Priority Data
Sep. 1, 2023 (CN) 202311126333.4

(51) Int. Cl. G06F 9/38

(52) U.S. Cl. CPC G06F 9/3867

(57) ABSTRACT

Embodiments of the disclosure provide a data processing method and apparatus, an electronic device, and a storage medium. The data processing method includes: determining, by a pipeline management class, a current pipeline class of media data to be processed; transmitting, by the pipeline management class, the media data to be processed to the current pipeline class; and processing, by the current pipeline class and next pipeline indication information corresponding to the current pipeline class, the media data to be processed to obtain processed media data, where the next pipeline indication information is used to indicate whether there is a next pipeline class for processing the media data to be processed. Processing steps are pipelined, and processing of the media data to be processed is implemented by a pipeline class, thereby solving the problem of poor maintainability of existing data processing codes.

The present application claims priority to Chinese Patent Application No. 202311126333.4, filed on Sep. 1, 2023, and entitled “DATA PROCESSING METHOD, APPARATUS, ELECTRONIC DEVICE, AND STORAGE MEDIUM”, the entire content of which is incorporated herein by reference.

### FIELD

Embodiments of the present disclosure relate to data processing technologies, and in particular, to a data processing method, apparatus, electronic device, and storage medium.

### BACKGROUND

With the continuous development of computer technologies, amount of data that needs to be processed is increasing. At present, when performing data processing, a software is developed for the purpose of the data processing, and a maintainability of the developed code is poor.

### SUMMARY

The present disclosure provides a data processing method, apparatus, electronic device, and storage medium to improve the maintainability of data processing.

In a first aspect, an embodiment of the present disclosure provides a data processing method including: determining, by a pipeline management class, a current pipeline class of media data to be processed; transmitting, by the pipeline management class, the media data to be processed to the current pipeline class; and processing, by the current pipeline class and next pipeline indication information corresponding to the current pipeline class, the media data to be processed to obtain processed media data, the next pipeline indication information being used to indicate whether a next pipeline class for processing the media data to be processed exists.

In a second aspect, an embodiment of the present disclosure further provides a data processing apparatus. The apparatus includes: a determination module configured to determine, by a pipeline management class, a current pipeline class of media data to be processed; a transmission module configured to transmit, by the pipeline management class, the media data to be processed to the current pipeline class; and a processing module configured to process, by the current pipeline class and next pipeline indication information corresponding to the current pipeline class, the media data to be processed to obtain processed media data, the next pipeline indication information being used to indicate whether a next pipeline class for processing the media data to be processed exists.

In a third aspect, an embodiment of the present disclosure further provides an electronic device. The electronic device includes one or more processing apparatuses and a storage apparatus. The storage apparatus is configured to store one or more programs, the one or more programs when executed by the one or more processing apparatuses, causing the one or more processing apparatuses to implement the data processing method according to the present disclosure.

In a fourth aspect, an embodiment of the present disclosure further provides a storage medium including computer-executable instructions, the computer-executable instructions, when executed by a computer processor, being configured to perform the data processing method according to the present disclosure.

### BRIEF DESCRIPTION OF DRAWINGS

The above and other features, advantages, and aspects of the embodiments of the present disclosure will become more apparent in combination with the accompanying drawings and with reference to the following detail description. Throughout the drawings, the same or similar reference numerals represent the same or similar elements. It should be understood that the drawings are schematic and that parts and elements are not necessarily drawn to scale.

FIG. 1 is a schematic flowchart of a data processing method according to embodiments of the present disclosure;

FIG. 2 is a schematic flowchart of a data processing method according to embodiments of the present disclosure;

FIG. 3 is a class diagram of a data processing method according to embodiments of the present disclosure;

FIG. 4 is a schematic scenario diagram of a data processing method according to embodiments of the present disclosure;

FIG. 5 is a schematic diagram of a structure of a data processing apparatus according to embodiments of the present disclosure; and

FIG. 6 is a schematic diagram of a structure of an electronic device according to embodiments of the present disclosure.

### DETAILED DESCRIPTION

The embodiments of the present disclosure are described in more detail below with reference to the drawings. Although some embodiments of the present disclosure are shown in the drawings, it should be understood that the present disclosure may be implemented in various forms and should not be construed as limited to the embodiments set forth herein. Instead, these embodiments are provided for a more thorough and complete understanding of the present disclosure. It should be understood that the drawings and embodiments of the present disclosure are only for purposes of example and are not intended to limit the protection scope of the present disclosure.

It should be understood that various steps described in the method implementations of the present disclosure may be performed in different orders and/or in parallel. In addition, the method implementations may include additional steps and/or omit the performance of the steps shown. The scope of the present disclosure is not limited in this regard.

The term “include/comprise” and the like used herein are open-ended inclusions, that is, “include/comprise but not limited to”. The term “based on” is “based at least partially on”. The term “an embodiment” means “at least one embodiment”. The term “another embodiment” means “at least one other embodiment”. The term “some embodiments” means “at least some embodiments”. Related definitions of other terms will be given in the following description.

It should be noted that concepts such as “first” and “second” mentioned in the present disclosure are only used to distinguish different apparatuses, modules, or units and are not used to limit the order or interdependence of the functions performed by these apparatuses, modules, or units.

It should be noted that the modifications of “one” and “multiple” mentioned in the present disclosure are illustrative rather than restrictive. Those skilled in the art should understand that unless otherwise explicitly specified in the context, the modifications should be understood as “one or more”.

The names of messages or information exchanged between multiple apparatuses in the implementations of the present disclosure are only for illustrative purposes and are not intended to limit the scope of these messages or information.

It may be understood that before using the technical solutions disclosed in the various embodiments of the present disclosure, the user should be informed of the type, range of use, use scenarios, etc., of personal information involved in the present disclosure in an appropriate manner in accordance with relevant laws and regulations and the authorization of the user should be obtained.

For example, in response to receiving an active request from a user, prompt information is sent to the user to clearly prompt the user that the requested operation will require obtaining and use of the personal information of the user. Thus, the user may independently choose, according to the prompt information, whether to provide the personal information to software or hardware, such as an electronic device, an application, a server, or a storage medium, that performs the operations of the technical solutions of the present disclosure.

As an optional but non-limiting implementation, in response to receiving the active request from the user, the prompt information may be sent to the user in the form of, for example, a pop-up window, in which the prompt information may be presented in text. Furthermore, the pop-up window may also carry a selection control for the user to choose whether to “agree” or “disagree” to provide the personal information to the electronic device.

It may be understood that the above process of notifying and obtaining user authorization is only for the purpose of example and does not constitute a limitation on the implementations of the present disclosure. Other manners that satisfy the relevant laws and regulations may also be applied to the implementations of the present disclosure.

It may be understood that the data involved in the technical solution (including but not limited to the data itself, acquisition or use of the data) should comply with the requirements of the corresponding laws, regulations, and related provisions.

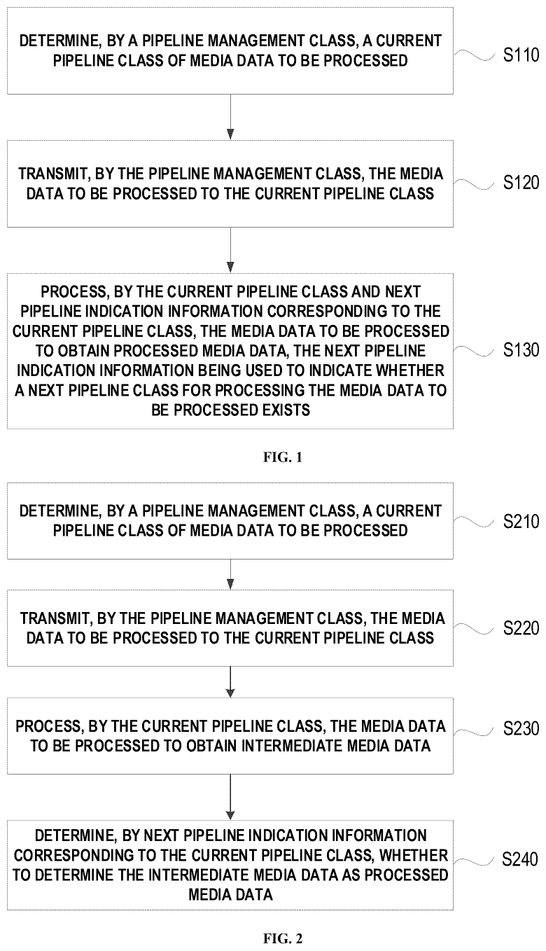

FIG. 1 is a schematic flowchart of a data processing method according to embodiments of the present disclosure. The embodiments of the present disclosure are applicable to cases of processing data. The method may be performed by a data processing apparatus, which may be implemented in the form of software and/or hardware, and optionally, implemented by an electronic device, which may be a mobile terminal, a PC, or a server, etc.

As shown in FIG. 1, the method includes:

S110: determining, by a pipeline management class, a current pipeline class of media data to be processed.

The pipeline management class may be considered as a class that implements pipeline management. In this embodiment, the processing of media data is abstracted into the processing of multimedia data through a pipeline. In the present disclosure, the code of each pipeline is independent and does not affect each other, and each pipeline may have an independent function. The function of the pipeline may be determined based on the media data that needs to be processed. The media data may be data in a form of, such as one or more of text, sound, image, and video. The media data to be processed may be considered as media data that is to be processed.

In an embodiment, in a case where the media data is audio data, the function of the pipeline includes but is not limited to echo cancellation, pitch determination, environmental sound effect addition, saving, headphone monitoring, and dumping.

In an embodiment, in a case where the media data is image data, the function of the pipeline includes but is not limited to filter applying, resolution adjustment, effect addition, and saving.

The pipeline in the present disclosure is implemented through a pipeline class, and the pipeline class includes a current pipeline class and a next pipeline class. The current pipeline class may be a pipeline class that is currently executed. The next pipeline class may be a pipeline class that is executed next.

The function of the pipeline management class may be to implement the management of the pipeline class, such as determining a head pipeline of the media data to be processed. The head pipeline may be a first pipeline that processes the data to be processed. The head pipeline class may be considered as a class that implements the function of the head pipeline.

In this embodiment, the pipeline class indicated in the pipeline management class may be determined as the current pipeline class for processing the media data to be processed.

S120: transmitting, by the pipeline management class, the media data to be processed to the current pipeline class. After determining the current pipeline class, the pipeline management class may transmit the media data to be processed to the current pipeline class through a transmission method in the pipeline management class. The transmission method may be a method for implementing data transmission, or the transmission method may be a method for implementing an interface.

S130: processing, by the current pipeline class and next pipeline indication information corresponding to the current pipeline class, the media data to be processed to obtain processed media data, the next pipeline indication information being used to indicate whether a next pipeline class for processing the media data to be processed exists.

The next pipeline indication information may be considered as indication information for the next pipeline class. The next pipeline class is used to process the media data to be processed. In a case where the next pipeline indication information indicates the next pipeline class, it may be considered that the next pipeline class exists, and the media data to be processed needs to continue to be processed by the next pipeline class. In a case where the next pipeline indication information does not indicate the next pipeline class, it may be considered that the next pipeline class does not exist, and the current pipeline class is also referred to as a tail pipeline class, and the processing of the media data to be processed may be ended. The tail pipeline class may be considered as a last pipeline class that processes the media data to be processed.

This embodiment does not limit the means for determining that the next pipeline indication information does not indicate the next pipeline class. For example, if the next pipeline indication information is empty or is set information, it may be determined that the next pipeline indication information does not indicate the next pipeline class.

In this step, when processing the media data to be processed by the current pipeline class and the next pipeline indication information corresponding to the current pipeline class, the media data to be processed may be processed by the current pipeline class, and the processing may be determined whether to end by the next pipeline indication information.

In the case where the next pipeline indication information does not indicate the next pipeline class, the processing result of the current pipeline class is used as the processed media data.

In the case where the next pipeline indication information indicates the next pipeline class, the processing result of the current pipeline class continues to be processed by the next pipeline class. During processing, the next pipeline class is used as a new current pipeline class, and the processing of the media data to be processed by the current pipeline class and the next pipeline indication information corresponding to the current pipeline class is continued until the next pipeline indication information indicates that the processing ends.

According to the technical solution of the embodiment of the present disclosure, the current pipeline class of the media data to be processed is determined by the pipeline management class. The media data to be processed is transmitted to the current pipeline class by the pipeline management class. The media data to be processed is processed by the current pipeline class and the next pipeline indication information corresponding to the current pipeline class to obtain the processed media data. During the process of processing the media data to be processed to obtain the processed media data, the processing steps are pipelined, and the processing of the media data to be processed is implemented through the pipeline class. Thereby the problem of poor maintainability of the existing data processing code is solved. The processing of the media data to be processed is implemented through the current pipeline class, and in the case where the data processing method needs to be maintained, only the pipeline class that needs to be maintained is maintained, thereby improving the maintainability of the data processing method.

Based on the above embodiments, variant embodiments of the above embodiments are proposed. It should be noted that, in order to make the description brief, only the differences from the above embodiments are described in the variant embodiments.

In an embodiment, the determining, by a pipeline management class, a current pipeline class of media data to be processed includes: determining, by the pipeline management class, head pipeline indication information of the current pipeline class, and determining a pipeline class indicated by the head pipeline indication information as the current pipeline class.

The head pipeline indication information may be considered as indication information of the pipeline class determined in the pipeline management class. The head pipeline indication information indicates the head pipeline class for processing the media data to be processed.

The head pipeline indication information may be stored in the pipeline management class, and the pipeline class indicated by the head pipeline indication information may be used as the current pipeline class.

In an embodiment, head pipeline indication information indicating an echo cancellation pipeline class may be stored in the pipeline management class. In this embodiment, the echo cancellation pipeline class may be used as the current pipeline class.

The pipeline management class may indicate multiple pieces of head pipeline indication information, each piece of head pipeline indication information may correspond to a respective pipeline class, each pipeline class may be used as a head pipeline class, each head pipeline class is a different branch for processing the media data to be processed, and the processing means of each branch may be independent.

The multiple pieces of head pipeline indication information indicated in the pipeline management class may be stored in the form of a list, and the specific storage manner is not limited here.

FIG. 2 is a schematic flowchart of a data processing method according to embodiments of the present disclosure. In the embodiments, the specific operation of processing the media data to be processed is detailed, and the data processing method includes the following steps.

S210: determining, by a pipeline management class, a current pipeline class of media data to be processed.

S220: transmitting, by the pipeline management class, the media data to be processed to the current pipeline class.

S230: processing, by the current pipeline class, the media data to be processed to obtain intermediate media data.

The intermediate media data may be considered as a processing result of the data to be processed after being processed by the current pipeline class. The intermediate media data may be determined based on the pipeline function of the current pipeline class. For example, if the current pipeline class is a pipeline that implements echo cancellation, the intermediate media data may be data obtained by performing echo cancellation on the media data to be processed. For another example, if the current pipeline class is a pipeline that determines a pitch, the intermediate media data may be media data of which the pitch is determined. For another example, if the current pipeline class is a pipeline that adds an environmental sound, the intermediate media data may be media data to which the environmental sound is added.

S240: determining, by next pipeline indication information corresponding to the current pipeline class, whether to determine the intermediate media data as processed media data.

In this embodiment, after the intermediate media data is obtained, the content indicated by the next pipeline indication information may be determined by the current pipeline class. Whether to determine the intermediate media data as the processed media data is determined based on the determined content. In a case where the processing ends, the intermediate media data may be used as the processed media data. In a case where the processing does not end, the intermediate media data may continue to be processed based on the next pipeline class indicated by the next pipeline indication information until the next pipeline indication information indicates that the processing ends.

In an embodiment, in a case where the next pipeline indication information indicates that the processing ends (or the next pipeline indication information does not indicate the next pipeline class), the intermediate media data is determined as the processed media data. In a case where the next pipeline indication information indicates the next pipeline class, the next pipeline class is used as a new current pipeline class, and the media data to be processed continues to be processed based on the current pipeline class and the corresponding next pipeline class.

According to the data processing method provided in this embodiment, when the media data to be processed is processed by the current pipeline class, whether the intermediate media data is used as the processed media data is determined by the corresponding next pipeline indication information. In this manner, whether the next pipeline class is required to process the media data to be processed is determined, and the order of execution of each pipeline class is determined by the next pipeline indication information.

Based on the above embodiments, variant embodiments of the above embodiments are proposed. It should be noted that, in order to make the description brief, only the differences from the above embodiments are described in the variant embodiments.

In an embodiment, the determining, by next pipeline indication information corresponding to the current pipeline class, whether to determine the intermediate media data as processed media data includes:

In a case that determining, by the current pipeline class, that the next pipeline indication information corresponding to the current pipeline class indicates that the current pipeline class is a tail pipeline class, the intermediate media data is determined as the processed media data.

The tail pipeline class may be a last executed pipeline class in the pipeline classes that process the media data to be processed. For example, the tail pipeline class is a last used pipeline class when implementing processing objective of the media data.

In an embodiment, the processing objective of the media data to be processed is to add an environmental sound effect and save. Thus, the head pipeline class may be a pipeline class that adds a sound effect, and the tail pipeline class may be a pipeline class that implements saving.

In a case where the next pipeline indication information indicates that the current pipeline class is the tail pipeline class, it may be considered that the processing of the media data to be processed may be completed after the execution of the current pipeline class, and thus the intermediate media data may be determined as the processed media data.

In an embodiment, the determining, by next pipeline indication information corresponding to the current pipeline class, whether to determine the intermediate media data as processed media data includes: determining, by the current pipeline class, the next pipeline indication information corresponding to the current pipeline class.

In a case where the next pipeline indication information indicates that a next pipeline class exists, the next pipeline class is used as the current pipeline class, and the intermediate media data is used as the media data to be processed. The processing of the media data to be processed by the current pipeline class and the next pipeline indication information corresponding to the current pipeline class is continued to obtain the processed media data.

In a case where the next pipeline indication information indicates that the next pipeline class exists, the intermediate media data still needs to continue to be processed by the next pipeline class. Therefore, in this embodiment, the next pipeline class is determined as the current pipeline class, the intermediate media data is determined as the media data to be processed, and the operation of processing the media data to be processed by the current pipeline class and the next pipeline indication information corresponding to the current pipeline class is continued to be performed to obtain the processed media data.

In an embodiment, each of the current pipeline classes is inherited from a same base class, each of the current pipeline classes performs a corresponding processing method based on the base class to process the media data to be processed, and a pipeline interface of the base class is used for media data transmission.

In the present disclosure, all current pipeline classes that implement data processing are inherited from the same base class. The base class may implement a pipeline interface and abstract a processing method. The current pipeline classes with different functions may abstract different processing methods to process the media data to be processed, such as an echo cancellation method, a pitch determination method, and/or a background sound addition method, and the like.

The base class implements the pipeline interface, and the pipeline interface is for media data transmission. The transmitted media data is not limited here, and the media data transmitted by different pipeline classes may be different. The media data transmitted by the pipeline class may include the media data obtained by the pipeline class and the media data sent by the pipeline class.

In an embodiment, in a case where the media data to be processed is audio, and the processing on the audio includes echo cancellation and saving, the head pipeline class may be an echo cancellation pipeline class, and the next pipeline class may be a saving pipeline class. When the next pipeline class is executed, the next pipeline class is used as the current pipeline class. When the echo cancellation pipeline class is used as the current pipeline class, the transmitted media data includes the media data to be processed and the echo-cancelled media data. The echo-cancelled media data may be used as the media data to be processed by the saving pipeline class, and the media data obtained by the saving pipeline class is the echo-cancelled media data.

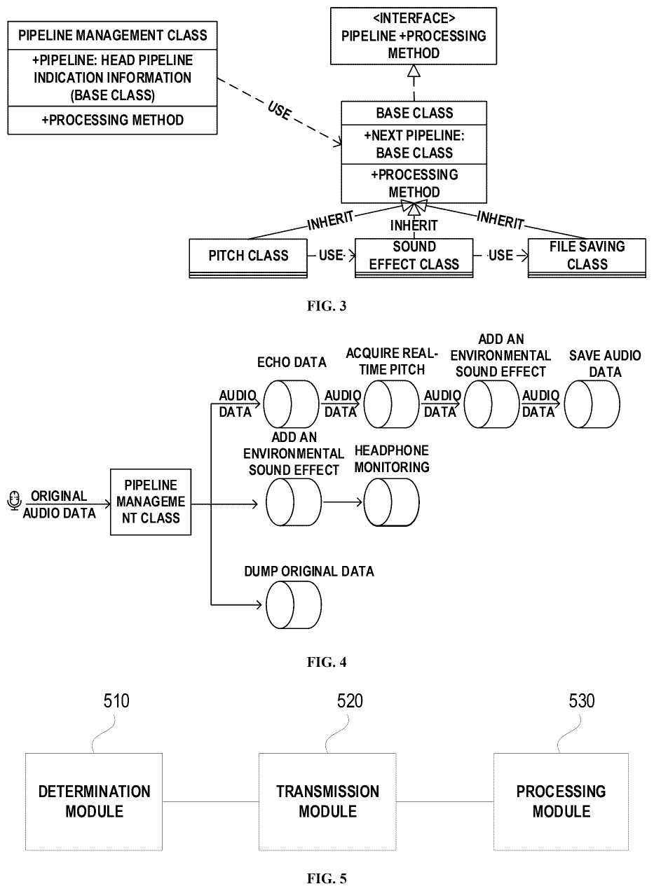

FIG. 3 is a class diagram of a data processing method according to an embodiment of the present disclosure. The pitch class may be a pipeline class for determining a pitch. The sound effect class may be a pipeline class for adding a sound effect. The file saving class may be a saving pipeline class. The pitch class, the sound effect class, and the saving class are inherited from (or extend) the base class. The pitch class uses the sound effect class, and the sound effect class uses the file saving class.

The next pipeline indication information in the base class may indicate the next pipeline. The processing method may implement transmission and data processing. For example, the processing method may include a transmission method, that is, a processAudio method, and on the basis of implementing transmission, the processAudio method may call an actual processing method, that is, a realProcess method, to implement the functions of each pipeline. The base class implements the pipeline interface, and the processing method may be declared in the pipeline interface.

The pipeline management class may include the head pipeline indication information to indicate the head pipeline. The media data to be processed is transmitted to the head pipeline class corresponding to the head pipeline through the processing method in the pipeline management class for processing. After the head pipeline processing, the subsequent processing strategy may be determined based on the next pipeline indication information in the head pipeline class.

In an embodiment, the media data to be processed is audio data, and the processing method corresponding to the current association class is an audio processing method.

In the case where the media data to be processed is audio data, the processing method executed by the pipeline class is the audio processing method. The specific processing means of the audio processing method are not limited here, as long as the required function may be implemented.

FIG. 4 is a schematic scenario diagram of a data processing method according to embodiments of the present disclosure. FIG. 4 illustrates three processing methods for the media data to be processed, and each processing method may be independent of each other. The media data to be processed may be original audio data, the original audio data is input to the pipeline management class, and the pipeline management class determines the head pipeline for processing the original audio data.

One processing method is to perform echo cancellation first, then acquire real-time pitch, then add an environmental sound effect, and finally save audio data. Another processing method is to add an environmental sound effect and then perform headphone monitoring. Still another processing method is to dump original data, that is, the original audio data.

In the above three processing methods, each processing method is performed separately, and the pipeline management class may store an identification of the echo cancellation pipeline class, an identification of the environmental sound effect addition pipeline class, and an identification of the dump pipeline class in the form of a list.

In the first processing method, the head pipeline class is the echo cancellation pipeline class. After this pipeline class processes the original audio data as the current pipeline class, the next pipeline class is determined to be a pipeline class for acquiring real-time pitch through the next pipeline indication information corresponding to the current pipeline class is. The pipeline class for acquiring real-time pitch is determined as a new current pipeline class, and the processing of acquiring real-time pitch is performed. The next pipeline class is determined to be the environmental sound effect addition pipeline class through the next pipeline indication information corresponding to the pipeline class for acquiring real-time pitch. The environmental sound effect addition pipeline class is used as the current pipeline class, and the processing of adding the environmental sound effect is performed, and the next pipeline class indicated by the next pipeline indication information in the management class for adding the environmental sound effect is determined, that is, an audio data saving pipeline class,. The audio data saving pipeline class is used as the current pipeline class, and the processing of saving the audio data is performed. If the next pipeline indication information in the audio data saving pipeline class indicates that the processing ends, the processing ends, for example, the operation is stopped.

In the second processing method, after the environmental sound effect addition pipeline class is used as the current pipeline class, the headphone monitoring pipeline class is used as the next pipeline class, thereby implementing headphone monitoring.

In the third processing method, the head pipeline is the tail pipeline, and the operation ends after the dumping is implemented through the dump pipeline class.

This embodiment does not limit the objective of determining the pitch, and the audio may be scored based on a comparison between the real-time acquired pitch and the theoretical pitch.

The data processing method provided in the present disclosure may be considered as an audio data link management method, and the operating system to which the method is applied is not limited. For example, the method is applied to the Android operating system. Specifically, the method is applied to a scenario of implementing audio data recording in the Android scenario. The recorded audio data (such as the recorded singing audio) may be processed in multiple steps, and the data processed by one step is the data input of the next step. For example, the audio data needs to be subjected to volume balance adjustment, tone adjustment, audio-related data (such as pitch) acquisition, and/or audio data saving. When there are a plurality of processing steps, these steps need to be abstracted for ease of maintenance (such as management and/or expansion).

In the present disclosure, the concept of a pipeline (Pipe) is abstracted from the audio data processing steps, and the audio data stream flowing through the Pipe may be processed or read and then handed over to the next Pipe after the processing is completed. The code of each Pipe is independent and does not affect each other. A unified PipeManager (or the pipeline management class) is used to manage the Pipe. Managing the audio data in the above manner may improve the code reusability (for example, the node of the environmental sound effect addition pipeline in FIG. 4 may be reused), maintainability, and expandability of the audio link.

In this embodiment, each audio processing function is encapsulated into a pipeline, which implements the reusability of the code. In a scenario where an environmental sound effect needs to be added, the environmental sound effect addition pipeline class may be directly used.

Each function is encapsulated into a pipeline, and during maintenance, only the function that needs to be maintained needs to be repaired. For example, if the processing means for environmental sound effect addition needs to be adjusted, only the environmental sound effect addition pipeline class needs to be adjusted.

Each function is encapsulated into a pipeline, and if different processing methods for the audio data need to be implemented, only each pipeline needs to be combined. For example, on the basis of the first implementation method in FIG. 4, if the processing method needs to be adjusted, for example, performing the dumping after the real-time pitch is acquired, the dump pipeline class may be indicated in the next pipeline indication information in the pipeline class for acquiring the real-time pitch. The adjustment of the first processing method may be implemented by indicating the environmental sound effect addition pipeline class in the next pipeline indication information of the dump pipeline class, which improves the expandability of data processing.

In the present disclosure, the pipeline interface is abstracted, and the pipeline interface abstracts the method for processing the audio data, such as the processAudio method. The base class, such as the BasePipe class, implements the pipeline interface. The BasePipe uses a linked list to describe the order of the pipeline, that is, next pipeline of the current pipeline is represented by the next pipeline indication information, such as nextPipe. The processAudio uses a template method, such as a realProcess method, to process the audio data, and the processed data is handed over to the next pipeline, that is, the nextPipe, for processing. The pipeline management class, such as PipeLineManager, is used to manage each pipeline.

After acquiring the media data to be processed, the processAudio method calls the realProcess method to implement processing, and then the processing is continued based on the next pipeline class indicated by the next pipeline indication information. For example, the processed data, such as the intermediate media data, is transmitted to the next pipeline class through the processAudio method for continued processing. After acquiring the intermediate media data, the processAudio method of the next pipeline class continues to call the realProcess method of the next pipeline class, and so on, until the next pipeline indication information indicates that the processing is completed.

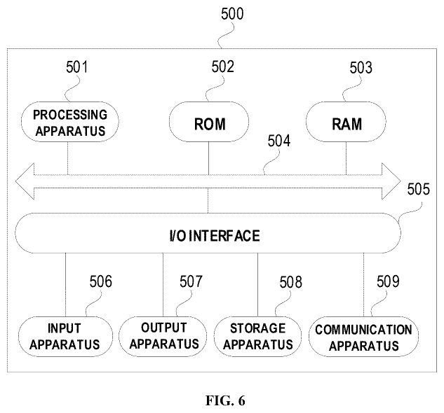

FIG. 5 is a schematic structural diagram of a data processing apparatus according to an embodiment of the present disclosure. As shown in FIG. 5, the apparatus includes: a determination module 510 configured to determine, by a pipeline management class, a current pipeline class of media data to be processed; a transmission module 520 configured to transmit, by the pipeline management class, the media data to be processed to the current pipeline class; and a processing module 530 configured to process, by the current pipeline class and next pipeline indication information corresponding to the current pipeline class, the media data to be processed to obtain processed media data, where the next pipeline indication information is used to indicate whether a next pipeline class for processing the media data to be processed exists.

According to the technical solution provided in the embodiment of the present disclosure, during the process of processing the media data to be processed to obtain the processed media data, the processing steps are pipelined, and the processing of the media data to be processed is implemented through the pipeline class, thereby solving the problem of poor maintainability of the existing data processing code. The processing of the media data to be processed is implemented through the current pipeline class, and in the case where the data processing method needs to be maintained, only the pipeline class that needs to be maintained is maintained, thereby improving the maintainability of the data processing method.

In an embodiment, the determination module 510 is specifically configured to: determine, by the pipeline management class, head pipeline indication information of the current pipeline class, and determine a pipeline class indicated by the head pipeline indication information as the current pipeline class.

In an embodiment, the processing module 530 includes: a processing unit configured to process, by the current pipeline class, the media data to be processed to obtain intermediate media data; and a determination unit configured to determine, by the next pipeline indication information corresponding to the current pipeline class, whether to determine the intermediate media data as the processed media data.

In an embodiment, the determination unit is specifically configured to: determine the intermediate media data as the processed media data in response to determine, by the current pipeline class, that the next pipeline indication information corresponding to the current pipeline class indicates that the current pipeline class is a tail pipeline class.

In an embodiment, the determination unit is specifically configured to: determine, in response to determine, by the current pipeline class, that the next pipeline indication information corresponding to the current pipeline class indicates a next pipeline class, the next pipeline class as the current pipeline class, the intermediate media data as the media data to be processed, and the processing of the media data to be processed by the current pipeline class and the next pipeline indication information corresponding to the current pipeline class is continued to obtain the processed media data.

In an embodiment, each of the current pipeline classes is inherited from a same base class, each of the current pipeline classes performs a corresponding processing method based on the base class to process the media data to be processed, and a pipeline interface of the base class is used for media data transmission.

In an embodiment, the media data to be processed is audio data, and the processing method corresponding to the current association class is an audio processing method.

The data processing apparatus provided in the embodiment of the present disclosure may perform the data processing method provided in any embodiment of the present disclosure and has the corresponding functional modules for performing the method and beneficial effects.

It is worth noting that the units and modules included in the above apparatus are only divided according to functional logic but are not limited to the above division, as long as the corresponding functions may be implemented. Furthermore, the specific names of the functional units are only for ease of distinguishing from each other and are not used to limit the protection scope of the embodiments of the present disclosure.

FIG. 6 is a schematic structural diagram of an electronic device according to an embodiment of the present disclosure. Reference is made to FIG. 6 below, which illustrates a schematic structural diagram of an electronic device (such as a terminal device or a server in FIG. 6) 500 suitable for implementing the embodiments of the present disclosure.

The electronic device 500 includes: one or more processing apparatuses 501; a storage apparatus 508 configured to store one or more programs, and the one or more programs when executed by the one or more processing apparatuses 501, cause the one or more processing apparatuses 501 to implement the data processing method according to the present disclosure.

The terminal device in the embodiments of the present disclosure may include, but is not limited to, mobile terminals such as a mobile phone, a notebook computer, a digital broadcast receiver, a personal digital assistant (PDA), a tablet computer, a portable multimedia player (PMP), and a vehicle-mounted terminal (such as a vehicle-mounted navigation terminal), and fixed terminals such as a digital TV and a desktop computer. The electronic device 500 shown in FIG. 6 is only an example and should not impose any limitation on the function and scope of use of the embodiments of the present disclosure.

As shown in FIG. 6, the electronic device 500 may include a processing apparatus (such as a central processing unit and a graphics processing unit) 501 that may perform various appropriate actions and processing according to a program stored in a read-only memory (ROM) 502 or a program loaded from a storage apparatus 508 into a random access memory (RAM) 503. The RAM 503 further stores various programs and data required for the operation of the electronic device 500. The processing apparatus 501, the ROM 502, and the RAM 503 are connected to each other through a bus 504. An edit/output (I/O) interface 505 is also connected to the bus 504.

Usually, the following apparatuses may be connected to the I/O interface 505: an input apparatus 506 such as a touchscreen, a touchpad, a keyboard, a mouse, a camera, a microphone, an accelerometer, and a gyroscope, and the like; an output apparatus 507 such as a liquid crystal display (LCD), a speaker, and a vibrator, and the like; the storage apparatus 508 including such as a magnetic tape, a hard disk and the like; and a communication apparatus 509. The communication apparatus 509 may allow the electronic device 500 to communicate wirelessly or with wires with other devices to exchange data. Although FIG. 6 illustrates the electronic device 500 having various apparatuses, it should be understood that it is not required to implement or have all the apparatuses shown. More or fewer apparatuses may be implemented or provided alternatively.

In particular, according to the embodiments of the present disclosure, the process described above with reference to the flowchart may be implemented as a computer software program. For example, an embodiment of the present disclosure includes a computer program product, which includes a computer program carried on a non-transitory computer-readable medium, where the computer program includes program code for performing the method shown in the flowchart. In such embodiments, the computer program may be downloaded and installed from a network through the communication apparatus 509, or installed from the storage apparatus 508, or installed from the ROM 502. When the computer program is executed by the processing apparatus 501, the above functions defined in the method of the embodiment of the present disclosure are performed.

The names of messages or information exchanged between multiple apparatuses in the implementations of the present disclosure are only for illustrative purposes and are not intended to limit the scope of these messages or information.

The electronic device 500 provided in the embodiment of the present disclosure belongs to the same inventive concept as the data processing method provided in the above embodiments. For the technical details not described in detail in this embodiment, reference may be made to the above embodiments, and this embodiment has the same beneficial effects as the above embodiments.

An embodiment of the present disclosure provides a computer storage medium having a computer program stored thereon, where the data processing method provided in the above embodiments is implemented when the program is executed by a processor.

It should be noted that the above computer-readable medium in the present disclosure may be a computer-readable signal medium, a computer-readable storage medium, or any combination thereof.

The computer storage medium may be a storage medium for computer-executable instructions, which, when executed by a computer processor, are configured to perform the method provided in the present disclosure.

The computer-readable storage medium may be, for example, but is not limited to, an electrical, magnetic, optical, electromagnetic, infrared, or semiconductor system, apparatus, or device, or any suitable combination thereof. More specific examples of the computer-readable storage medium may include, but are not limited to, an electrical connection having one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium that contains or stores a program, which may be used by or in combination with an instruction execution system, apparatus, or device. In the present disclosure, the computer-readable signal medium may include a data signal propagated on a baseband or as a part of a carrier, and computer-readable program code is carried in the data signal. The data signal propagated in this manner may be in multiple forms and includes, but is not limited to, an electromagnetic signal, an optical signal, or any suitable combination thereof. The computer-readable signal medium may also be any computer-readable medium other than the computer-readable storage medium, and the computer-readable signal medium may send, propagate, or transmit the program used by or in combination with the instruction execution system, apparatus, or device. The program code contained on the computer-readable medium may be transmitted in any suitable medium, including but not limited to a wire, an optical cable, a radio frequency (RF), or any suitable combination thereof.

In some implementations, the client and the server may communicate using any currently known or future developed network protocol, such as the hypertext transfer protocol (HTTP), and may be interconnected with any form or medium of digital data communication (for example, a communication network). Examples of the communication network include a local area network (“LAN”), a wide area network (“WAN”), an internet (for example, the Internet), a peer-to-peer network (for example, an Ad-Hoc network), and any network currently known or to be developed in the future.

The above computer-readable medium may be included in the above electronic device or may exist alone without being assembled into the electronic device.

The above computer-readable medium carries one or more programs, which, when executed by the electronic device, cause the electronic device to: determine, by a pipeline management class, a current pipeline class of media data to be processed; transmit, by the pipeline management class, the media data to be processed to the current pipeline class; and process, by the current pipeline class and next pipeline indication information corresponding to the current pipeline class, the media data to be processed to obtain processed media data, where the next pipeline indication information is used to indicate whether a next pipeline class for processing the media data to be processed exists.

The computer program code for performing the operations of the present disclosure may be written in one or more programming languages or a combination thereof, where the above programming languages include, but are not limited to, an object-oriented programming language, such as Java, Smalltalk, and C++, and further include conventional procedural programming languages, such as “C” language or similar programming languages. The program code may be executed entirely on a computer of a user, partly executed on a computer of a user, executed as an independent software package, partly executed on a computer of a user and partly executed on a remote computer, or entirely executed on a remote computer or server. In the case of involving a remote computer, the remote computer may be connected to a computer of the user through any kind of network, including a local area network (LAN) or a wide area network (WAN), or may be connected to an external computer (for example, connected through the Internet using an Internet service provider).

The flowcharts and block diagrams in the drawings illustrate the possibly implemented architectures, functions, and operations of the system, the method, and the computer program product according to various embodiments of the present disclosure. In this regard, each block in the flowchart or block diagram may represent a module, program segment, or part of code, the module, program segment, or part of code contains one or more executable instructions for implementing the specified logical functions. It should also be noted that, in some alternative implementations, the functions marked in the blocks may also occur in an order different from that marked in the drawings. For example, two blocks shown in succession may actually be performed substantially in parallel, or they may sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The modules or units involved in the embodiments of the present disclosure may be implemented in a software manner or a hardware manner. The name of a module or unit does not constitute a limitation on the unit itself under certain circumstances. For example, the determination module may also be described as a “current pipeline class determination module”.

The functions described above herein may be performed at least in part by one or more hardware logic components. For example, without limitation, exemplary types of hardware logic components that may be used include: field programmable gate array (FPGA), application specific integrated circuit (ASIC), application specific standard product (ASSP), system on chip (SOC), complex programmable logical device (CPLD) and more.

In the context of the present disclosure, a machine-readable medium may be a tangible medium that may contain or store a program for use by or in combination with an instruction execution system, apparatus or device. The machine-readable medium may be a machine-readable signal medium or a machine-readable storage medium. The machine-readable medium includes, but is not limited to, an electronic, magnetic, optical, electromagnetic, infrared, or semiconductor system, apparatus or device, or any suitable combination thereof. More specific examples of the machine-readable storage medium would include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

According to one or more embodiments of the present disclosure, [Example 1] provides a data processing method. The method includes: determining, by a pipeline management class, a current pipeline class of media data to be processed; transmitting, by the pipeline management class, the media data to be processed to the current pipeline class; and processing, by the current pipeline class and next pipeline indication information corresponding to the current pipeline class, the media data to be processed to obtain processed media data, where the next pipeline indication information is used to indicate whether there is a next pipeline class for processing the media data to be processed.

According to one or more embodiments of the present disclosure, [Example 2] provides the method of Example 1, where the determining, by a pipeline management class, a current pipeline class of media data to be processed includes: determining, by the pipeline management class, head pipeline indication information of the current pipeline class, and determining a pipeline class indicated by the head pipeline indication information as the current pipeline class.

According to one or more embodiments of the present disclosure, [Example 3] provides the method of Example 1, where the processing, by the current pipeline class and next pipeline indication information corresponding to the current pipeline class, the media data to be processed to obtain processed media data includes: processing, by the current pipeline class, the media data to be processed to obtain intermediate media data; and determining, by the next pipeline indication information corresponding to the current pipeline class, whether to determine the intermediate media data as the processed media data.

According to one or more embodiments of the present disclosure, [Example 4] provides the method of Example 3, where the determining, by the next pipeline indication information corresponding to the current pipeline class, whether to determine the intermediate media data as the processed media data includes: determining, by the current pipeline class, that in a case where the next pipeline indication information corresponding to the current pipeline class indicates that the current pipeline class is a tail pipeline class, the intermediate media data is determined as the processed media data.

According to one or more embodiments of the present disclosure, [Example 5] provides the method of Example 3, where the determining, by the next pipeline indication information corresponding to the current pipeline class, whether to determine the intermediate media data as the processed media data includes: determining, by the current pipeline class, that in a case where the next pipeline indication information corresponding to the current pipeline class indicates a next pipeline class, the next pipeline class is used as the current pipeline class, the intermediate media data is used as the media data to be processed, and the processing of the media data to be processed by the current pipeline class and the next pipeline indication information corresponding to the current pipeline class is continued to obtain the processed media data.

According to one or more embodiments of the present disclosure, [Example 6] provides the method of Example 5, where each of the current pipeline classes is inherited from a same base class, each of the current pipeline classes performs a corresponding processing method based on the base class to process the media data to be processed, and a pipeline interface of the base class is used for media data transmission.

According to one or more embodiments of the present disclosure, [Example 7] provides the method of Example 1, where the media data to be processed is audio data, and the processing method corresponding to the current association class is an audio processing method.

According to one or more embodiments of the present disclosure, [Example 8] provides a data processing apparatus. The apparatus includes a determination module, a transmission module, and a processing module. The determination module is configured to determine, by a pipeline management class, a current pipeline class of media data to be processed. The transmission module is configured to transmit, by the pipeline management class, the media data to be processed to the current pipeline class. The processing module is configured to process, by the current pipeline class and next pipeline indication information corresponding to the current pipeline class, the media data to be processed to obtain processed media data, where the next pipeline indication information is used to indicate whether there is a next pipeline class for processing the media data to be processed.

According to one or more embodiments of the present disclosure, [Example 9] provides an electronic device. The electronic device includes one or more processing apparatuses and a storage apparatus. The storage apparatus is configured to store one or more programs, and the one or more programs upon execution by the one or more processing apparatuses, cause the one or more processing apparatuses to implement the data processing method according to any one of Examples 1-7.

According to one or more embodiments of the present disclosure, [Example 10] provides a storage medium including computer-executable instructions, where the computer-executable instructions, when executed by a computer processor, are configured to perform the data processing method according to any one of Examples 1-7.

The above description only illustrates preferred embodiments of the present disclosure and applied technical principles. Those skilled in the art should understand that the disclosed scope involved in the present disclosure is not limited to the technical solutions formed by specific combinations of the above technical features, and should also cover other technical solutions formed by any combination of the above technical features or equivalent features thereof without departing from the above disclosed concept. For example, the above features and the technical features provided in the present disclosure (but not limited to) with similar functions may be replaced each other to form a technical solution.

Furthermore, although the various operations are depicted in a specific order, this should not be understood as requiring the operations to be performed in the specific order shown or in a sequential order. Under certain circumstances, multitasking and parallel processing may be advantageous. Similarly, although the above discussion contains a number of specific implementation details, these should not be interpreted as limiting the scope of the present disclosure. Certain features described in the context of separate embodiments may also be implemented in a single embodiment in combination. Conversely, various features described in the context of a single embodiment may also be implemented in multiple embodiments individually or in any suitable sub-combination.

Although the subject matter has been described in terms specific to the structural features and/or logical actions of the method, it should be understood that the subject matter defined in the appended claims is not necessarily limited to the specific features or actions described above. Conversely, the specific features and actions described above are only exemplary forms of implementing the claims.

1. A data processing method, comprising:
determining, by a pipeline management class, a current pipeline class of media data to be processed;
transmitting, by the pipeline management class, the media data to be processed to the current pipeline class; and
processing, by the current pipeline class and next pipeline indication information corresponding to the current pipeline class, the media data to be processed to obtain processed media data, the next pipeline indication information being used to indicate whether a next pipeline class for processing the media data to be processed exists.

2. The method of claim 1, wherein the determining, by the pipeline management class, the current pipeline class of the media data to be processed comprises:
determining, by the pipeline management class, head pipeline indication information of the current pipeline class, and determining a pipeline class indicated by the head pipeline indication information as the current pipeline class.

3. The method of claim 1, wherein the processing, by the current pipeline class and the next pipeline indication information corresponding to the current pipeline class, the media data to be processed to obtain the processed media data comprises:
processing, by the current pipeline class, the media data to be processed to obtain intermediate media data; and
determining, by the next pipeline indication information corresponding to the current pipeline class, whether to determine the intermediate media data as the processed media data.

4. The method of claim 3, wherein the determining, by the next pipeline indication information corresponding to the current pipeline class, whether to determine the intermediate media data as the processed media data comprises:
determining the intermediate media data as the processed media data in response to determine, by the current pipeline class, that the next pipeline indication information corresponding to the current pipeline class indicates that the current pipeline class is a tail pipeline class.

5. The method of claim 3, wherein the determining, by the next pipeline indication information corresponding to the current pipeline class, whether to determine the intermediate media data as the processed media data comprises:
determining, by the current pipeline class, the next pipeline indication information corresponding to the current pipeline class; and
determining, in response to the next pipeline indication information indicating an existence of next pipeline class, the next pipeline class as the current pipeline class, the intermediate media data as the media data to be processed, and continuing to perform the processing of the media data to be processed by the current pipeline class and the next pipeline indication information corresponding to the current pipeline class to obtain the processed media data.

6. The method of claim 5, wherein each of the current pipeline classes is inherited from a same base class, each of the current pipeline classes performs a corresponding processing method based on the base class to process the media data to be processed, and a pipeline interface of the base class is used for media data transmission.

7. The method of claim 1, wherein the media data to be processed is audio data, and a processing method corresponding to a current association class is an audio processing method.

8. (canceled)

9. An electronic device, comprising:
one or more processors; and
a storage apparatus configured to store one or more programs,
the one or more programs, when executed by the one or more processors, causing the one or more processors to implement operations comprising:
determining, by a pipeline management class, a current pipeline class of media data to be processed;
transmitting, by the pipeline management class, the media data to be processed to the current pipeline class; and
processing, by the current pipeline class and next pipeline indication information corresponding to the current pipeline class, the media data to be processed to obtain processed media data, the next pipeline indication information being used to indicate whether a next pipeline class for processing the media data to be processed exists.

10. A non-transitory storage medium comprising computer-executable instructions, the computer-executable instructions, when executed by a computer processor, being configured to perform operations comprising:
determining, by a pipeline management class, a current pipeline class of media data to be processed;
transmitting, by the pipeline management class, the media data to be processed to the current pipeline class; and
processing, by the current pipeline class and next pipeline indication information corresponding to the current pipeline class, the media data to be processed to obtain processed media data, the next pipeline indication information being used to indicate whether a next pipeline class for processing the media data to be processed exists.

11. The electronic device of claim 9, wherein the determining, by the pipeline management class, the current pipeline class of the media data to be processed comprises:
determining, by the pipeline management class, head pipeline indication information of the current pipeline class, and determining a pipeline class indicated by the head pipeline indication information as the current pipeline class.

12. The electronic device of claim 9, wherein the determining, by the pipeline management class, the current pipeline class of the media data to be processed comprises:
determining, by the pipeline management class, head pipeline indication information of the current pipeline class, and determining a pipeline class indicated by the head pipeline indication information as the current pipeline class.

13. The electronic device of claim 12, wherein the determining, by the next pipeline indication information corresponding to the current pipeline class, whether to determine the intermediate media data as the processed media data comprises:
determining the intermediate media data as the processed media data in response to determine, by the current pipeline class, that the next pipeline indication information corresponding to the current pipeline class indicates that the current pipeline class is a tail pipeline class.

14. The electronic device of claim 12, wherein the determining, by the next pipeline indication information corresponding to the current pipeline class, whether to determine the intermediate media data as the processed media data comprises:
determining, by the current pipeline class, the next pipeline indication information corresponding to the current pipeline class; and
determining, in response to the next pipeline indication information indicating an existence of next pipeline class, the next pipeline class as the current pipeline class, the intermediate media data as the media data to be processed, and continuing to perform the processing of the media data to be processed by the current pipeline class and the next pipeline indication information corresponding to the current pipeline class to obtain the processed media data.

15. The electronic device of claim 14, wherein each of the current pipeline classes is inherited from a same base class, each of the current pipeline classes performs a corresponding processing method based on the base class to process the media data to be processed, and a pipeline interface of the base class is used for media data transmission.

16. The electronic device of claim 15, wherein the media data to be processed is audio data, and a processing method corresponding to a current association class is an audio processing method.

17. The non-transitory storage medium of claim 10, wherein the determining, by the pipeline management class, the current pipeline class of the media data to be processed comprises:
determining, by the pipeline management class, head pipeline indication information of the current pipeline class, and determining a pipeline class indicated by the head pipeline indication information as the current pipeline class.

18. The non-transitory storage medium of claim 10, wherein the processing, by the current pipeline class and the next pipeline indication information corresponding to the current pipeline class, the media data to be processed to obtain the processed media data comprises:
processing, by the current pipeline class, the media data to be processed to obtain intermediate media data; and
determining, by the next pipeline indication information corresponding to the current pipeline class, whether to determine the intermediate media data as the processed media data.

19. The non-transitory storage medium of claim 18, wherein the determining, by the next pipeline indication information corresponding to the current pipeline class, whether to determine the intermediate media data as the processed media data comprises:
determining the intermediate media data as the processed media data in response to determine, by the current pipeline class, that the next pipeline indication information corresponding to the current pipeline class indicates that the current pipeline class is a tail pipeline class.

20. The non-transitory storage medium of claim 18, wherein the determining, by the next pipeline indication information corresponding to the current pipeline class, whether to determine the intermediate media data as the processed media data comprises:
determining, by the current pipeline class, the next pipeline indication information corresponding to the current pipeline class; and
determining, in response to the next pipeline indication information indicating an existence of next pipeline class, the next pipeline class as the current pipeline class, the intermediate media data as the media data to be processed, and continuing to perform the processing of the media data to be processed by the current pipeline class and the next pipeline indication information corresponding to the current pipeline class to obtain the processed media data.

21. The non-transitory storage medium of claim 20, wherein each of the current pipeline classes is inherited from a same base class, each of the current pipeline classes performs a corresponding processing method based on the base class to process the media data to be processed, and a pipeline interface of the base class is used for media data transmission.
